(19) United States
(12) Patent Application Publication
(10) Pub. No.: US 2007/0175647 A1
(43) Pub. Date: Aug. 2, 2007

(54) Impact power tool

(75) Inventor: Yonosuke Aoki, Anjo-shi (JP)

Correspondence Address: OLIFF & BERRIDGE, PLC, P.O. BOX 19928, ALEXANDRIA, VA, 22320, US

(73) Assignee: MAKITA CORPORATION, ANJO-SHI (JP)

(21) Appl. No.: 11/698,926

(22) Filed: Jan. 29, 2007

(30) Foreign Application Priority Data
Feb. 1, 2006 (JP) 2006-025136

(51) Int. Cl. B23B 45/16

(52) U.S. Cl. 173/210

(57) ABSTRACT

An object of the invention is to provide an improved technique for lessening an imp force caused by rebound of a tool bit after its striking movement in an impact power tool. representative impact power tool comprises a tool body, a hammer actuating member, a holder, a driving mechanism, a weight placed in contact with the hammer actuating member move rearward by a reaction force transmitted from the hammer actuating member when hammer actuating member performs a hammering operation on the workpiece and an ela element elastically deformed when the weight moves rearward in the tool body to push the ela element such that the elastic element absorbs the reaction force transmitted to the weight. weight is defined one or both of the cylinder and the tool holder.

### BACKGROUND OF THE INVENTION

1. Field of the Invention

The present invention relates to an impact power tool for performing a linear hammer operation on a workpiece, and more particularly to a technique for cushioning a reaction fo received from the workpiece during hammering operation.

2. Description of the Related Art

Japanese non-examined laid-open Patent Publication No. 8-318342 discloses technique for cushioning an impact force caused by rebound of a tool bit after its strik movement in a hammer drill. In the known hammer drill, a rubber ring is disposed between axial end surface of a cylinder and an impact bolt. The rubber ring has a function of cushion the impact force caused by rebound of the tool bit and positioning the hammer drill during hammering operation. It is advantageous to make the rubber ring soft in order to absorb rebound of the tool bit. On the contrary, it is advantageous to make the rubber ring hard in order improve the positioning accuracy. Thus, while two different properties are required to the kno rubber ring, it is difficult to provide the rubber ring with a hardness that satisfies the b functional requirements. In this point, further improvement is required.

### SUMMARY OF THE INVENTION

Accordingly, it is an object of the invention to provide an improved technique lessening an impact force caused by rebound of a tool bit after its striking movement in an imp power tool.

The above-described problem can be solved by the features of the claimed invention The representative impact power tool according to the invention includes a tool body, a hamm actuating member disposed in a tip end region of the tool body to perform a predetermin hammering operation on a workpiece by reciprocating movement in its axial diction, a to holder that houses the hammer actuating member for axial movement, a driving mechanism th linearly drives the hammer actuating member, and a cylinder that houses the driving mechanism

The “predetermined hammering operation” in this invention includes not only hammering operation in which the hammer actuating member performs only a linear striki movement in the axial direction, but a hammer drill operation in which it performs a linear strikin movement and a rotation in the circumferential direction. The “hammer actuating membe according to the invention may preferably and typically be defined by a tool bit, or by a tool and an impact bolt that transmits a striking force in contact with the tool bit. Further, the “drivi mechanism” according to the invention typically comprises a driving element in the form of piston which reciprocates within the cylinder, and a striking element in the form of a striker whi reciprocates by pressure fluctuations caused by the reciprocating movement of the piston with the air chamber and strikes the impact bolt.

The representative impact power tool includes a weight and an elastic element. Wh the hammer actuating member performs a hammering operation on the workpiece, the cushioni weight is placed in contact with the hammer actuating member and can be caused to mo rearward in the tool body by a reaction force transmitted from the hammer actuating member. T elastic element is elastically deformed when the weight is caused to move rearward in the to body and pushes the elastic element, whereby the elastic element absorbs the reaction fo transmitted to the weight. Further, the weight comprises either the cylinder or the tool holder. T “elastic element” typically comprises a spring, but it may comprise a rubber.

During hammering operation, the hammer actuating member is caused to rebound receiving the reaction force of the workpiece after striking movement. According to the inventi with the construction in which the reaction force is transmitted from the hammer actuati member to the weight in the position in which the weight is placed in contact with the hamm actuating member, the reaction force is nearly 100% transmitted. In other words, the reacti force is transmitted by exchange of momentum between the hammer actuating member and t weight. By this transmission of the reaction force, the weight is caused to move rearward in t direction of action of the reaction force. The rearward moving weight elastically deforms t elastic element, and the reaction force of the weight is absorbed by such elastic deformati Specifically, according to this invention, the impact force (reaction force) caused by rebound the hammer actuating member can be absorbed by the rearward movement of the weight and the elastic deformation of the elastic element which is caused by the movement of the weight. a result, vibration of the impact power tool can be reduced.

According to this invention, either the cylinder or the tool holder as an existing p forming the main part of the impact power tool may be utilized to define the cushioning weig Therefore, the weight can be easily secured without increasing the mass of the impact power to Further, with the construction in which the existing part is utilized, compared with the case, t example, in which a cushioning weight is provided as an additional member, the structure can simpler, and the assembling operation is not complicated.

As another aspect of the invention, the weight may preferably be placed in contact w the hammer actuating member via an intervening member made of metal and is caused to mo rearward in the tool body by receiving a reaction force from the hammer actuating member via intervening member. The “intervening member made of metal” typically comprises a ring-li metal washer or a metal cylindrical element, and it also suitably includes a metal interveni member divided in the circumferential direction, or a plurality of metal intervening memb disposed in series in the axial direction of the hammer bit. With the construction in which cushioning weight contacts the hammer actuating member via the metal intervening member, example, by adjusting the length of the intervening member in the axial direction of the hamm bit, the reaction force of the hammer actuating member can be transmitted to the weight while cylinder or the tool holder which forms the weight is held in the existing position of placement the axial direction of the hammer bit.

Further, as another aspect of the invention, when the weight comprises the cylinder, cylinder may preferably include a rear cylinder element that comprises a rear portion of cylinder and forms the weight and a front cylinder element that comprises a front portion of cylinder. The rear cylinder element is separated from the front cylinder element and placed contact with the hammer actuating member via the front cylinder element or via the me intervening member and the front cylinder element in series. Further, the rear cylinder element caused to move rearward in the tool body by a reaction force transmitted from the hamm actuating member via the front cylinder element or via the metal intervening member and the fro cylinder element. Thus, the rear cylinder element can be utilized as a weight for cushioning reaction force while housing the piston and the striker which form the driving mechanism. T front cylinder element can be utilized as a reaction force transmitting member that transmits reaction force of the hammer actuating member to the rear cylinder element.

As another aspect of the invention, while the weight comprises the tool holder, the t holder may preferably include a rear tool holder element that comprises a rear portion of the t holder and forms the weight and a front tool holder element that comprises a front portion of tool holder. The rear tool holder element is separated from the front tool holder element placed in contact with the hammer actuating member. Further, the rear tool holder elemen caused to move rearward in the tool body by a reaction force transmitted from the ham actuating member. Thus, the front tool holder element can be provided with a function of hold the hammer actuating member, and the rear tool holder element can be utilized as a cushion weight.

As another aspect of the invention, the hammer actuating member may prefera include an impact bolt that is linearly driven in the axial direction by the driving mechanism, an tool bit that is caused to reciprocate by receiving a striking force from the impact bolt and the performs a hammering operation on the workpiece. Further, during hammering operation on workpiece, the impact bolt transmits the reaction force from the workpiece to the weight contact with the weight. Thus, the efficiency of transmission of the reaction force to the wei increases, so that the impact absorbing function can be enhanced.

As another aspect of the invention, the hammer actuating member may prefera include an impact bolt that is linearly driven in the axial direction by the driving mechanism, an tool bit that is caused to reciprocate by receiving a striking force from the impact bolt and ther performs a hammering operation on the workpiece. Further, the tool holder rotates on the axis the hammer actuating member to thereby cause the tool bit to rotate, so that the tool bit perform hammer drill operation by linear striking movement via the driving mechanism and the imp bolt and by rotation via the tool holder. The “tool holder” may preferably and typically includ bit holding part and an extension that extends rearward from the bit holding part in the ax direction and functions as a power transmitting part that receives a rotation driving force. Th the impact power tool can be provided in which the hammer actuating member can perfo rotation on its axis in addition to the linear striking movement.

Other objects, features and advantages of the present invention will be read understood after reading the following detailed description together with the accompanyi drawings and the claims.

### BRIEF DESCRIPTION OF THE DRAWINGS

FIG. 1 is a sectional side view schematically showing an entire electric hammer d according to a first embodiment of the invention under loaded conditions in which a hammer bit pressed against a workpiece.

FIG. 2 is an enlarged sectional view showing an essential part of the hammer drill.

FIG. 3 is a sectional plan view showing the entire hammer drill.

FIG. 4 is a sectional plan view showing an electric hammer drill according to a seco embodiment of the invention under loaded conditions in which the hammer bit is pressed agains workpiece.

FIG. 5 is a sectional plan view showing the hammer drill during operation of an impa damper.

FIG. 6 is a partially enlarged view of FIG. 4.

FIG. 7 is a sectional plan view showing an electric hammer drill according to a thi embodiment of the invention under loaded conditions in which the hammer bit is pressed against workpiece.

FIG. 8 is a sectional plan view showing the hammer drill during operation of the impa damper.

FIG. 9 is a partially enlarged view of FIG. 7.

FIG. 10 is a sectional plan view showing an electric hammer drill according to embodiment as a reference example of the invention under loaded conditions in which th hammer bit is pressed against a workpiece.

FIG. 11 is a sectional plan view showing the hammer drill during operation of the impa damper.

FIG. 12 is a partially enlarged view of FIG. 7.

### DETAILED DESCRIPTION OF THE INVENTION

Each of the additional features and method steps disclosed above and below may b utilized separately or in conjunction with other features and method steps to provide an manufacture improved impact power tools and method for using such impact power tools an devices utilized therein. Representative examples of the present invention, which example utilized many of these additional features and method steps in conjunction, will now be describe in detail with reference to the drawings. This detailed description is merely intended to teach person skilled in the art further details for practicing preferred aspects of the present teachings an is not intended to limit the scope of the invention. Only the claims define the scope of the claime invention. Therefore, combinations of features and steps disclosed within the following detaile description may not be necessary to practice the invention in the broadest sense, and are instea taught merely to particularly describe some representative examples of the invention, whic detailed description will now be given with reference to the accompanying drawings.

### First Embodiment

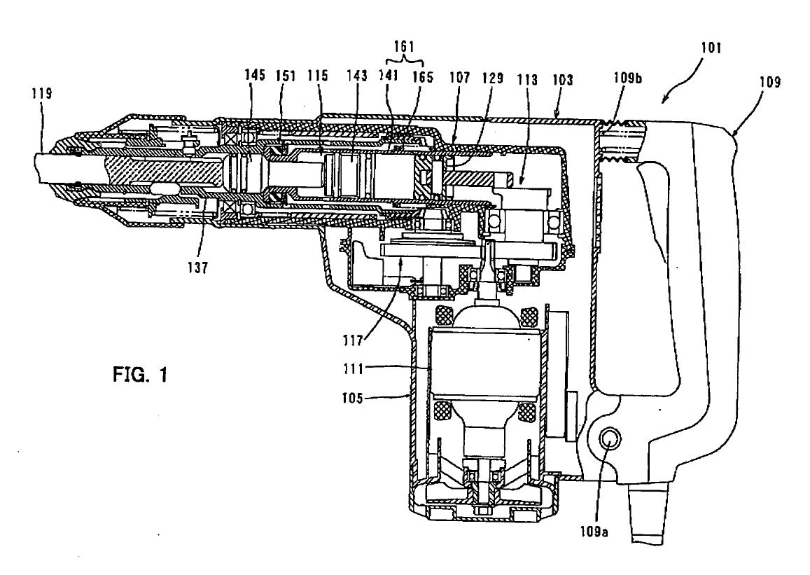

A first embodiment of the present invention will now be described with referenc FIGS. 1 to 3. FIG. 1 is a sectional side view showing an entire electric hammer drill 101 a representative embodiment of the impact power tool according to the present invention, un loaded conditions in which a hammer bit is pressed against a workpiece. As shown in FIG. 1, hammer drill 101 includes a body 103, a hammer bit 119 detachably coupled to the tip end reg (on the left side as viewed in FIG. 1) of the body 103 via a tool holder 137, and a handgrip 1091 is held by a user and connected to the rear end region of the body 103 on the side opposite hammer bit 119. The body 103 is a feature that corresponds to the “tool body” according to present invention. The hammer bit 119 is held by the hollow tool holder 137 such that it is allow to reciprocate with respect to the tool holder 137 in its axial direction and prevented from rotat with respect to the tool holder 137 in its circumferential direction. The hammer bit 119 is a feat that corresponds to the “tool bit” according to the invention. According to the embodiment, for sake of convenience of explanation, the side of the hammer bit 119 is taken as the front side the side of the handgrip 109 as the rear side.

The body 103 includes a motor housing 105 that houses a driving motor 111, and a g housing 107 that houses a motion converting mechanism 113, a power transmitting mechani 117 and a striking mechanism 115. The motion converting mechanism 113 is adapted appropriately convert the rotating output of the driving motor 111 to linear motion and then transmit it to the striking mechanism 115. As a result, an impact force is generated in the a direction of the hammer bit 119 via the striking mechanism 115. Further, the speed of the rotati output of the driving motor 111 is appropriately reduced by the power transmitting mechani 117 and then transmitted to the hammer bit 119. As a result, the hammer bit 119 is caused to in the circumferential direction. The handgrip 109 is generally U-shaped in side view, havi lower end and an upper end. The lower end of the handgrip 109 is rotatably connected to the end lower portion of the motor housing 105 via a pivot 109a, and the upper end is connected to rear end upper portion of the motor housing 105 via an elastic spring 109b for absorbing vibrat Thus, the transmission of vibration from the body 103 to the handgrip 109 is reduced.

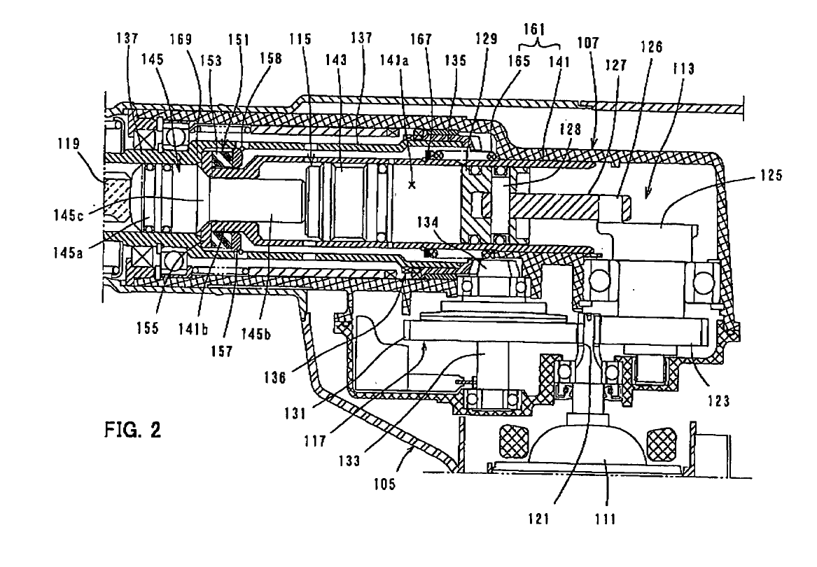

FIG. 2 is an enlarged sectional view showing an essential part of the hammer drill The motion converting mechanism 113 includes a driving gear 121 that is rotated in a horizo plane by the driving motor 111, a driven gear 123 that engages with the driving gear 121, a c plate 125 that rotates together with the driven gear 123 in a horizontal plane, a crank arm 127 is loosely connected at one end to the crank plate 125 via an eccentric shaft 126 in a posi displaced a predetermined distance from the center of rotation of the crank plate 125, and a driv element in the form of a piston 129 mounted to the other end of the crank arm 127 via a connect shaft 128. The crank plate 125, the crank arm 127 and the piston 129 form a crank meclanis

The power transmitting mechanism 117 includes a driving gear 121 that is driven by driving motor 111, a transmission gear 131 that engages with the driving gear 121, a transmiss shaft 133 that is caused to rotate in a horizontal plane together with the transmission gear 13 small bevel gear 134 mounted onto the transmission shaft 133, a large bevel gear 135 that enga with the small bevel gear 134, and the tool holder 137 that is caused to rotate together with large bevel gear 135 in a vertical plane. The tool holder 137 includes a bit holding part for hold the hammer bit 119 and an extension that extends rearward from the bit holding part in the a direction. The extension is connected to the large bevel gear 135 via an engagement clutch 1 Thus, the extension of the tool holder 137 serves as a power transmitting part that receive rotation driving force from the large bevel gear 135.

The striking mechanism 115 includes a striker 143 that is slidably disposed toge with the piston 129 within the bore of a cylinder 141. The striker 143 is driven via the action air spring of an air chamber 141a of the cylinder 141 which is caused by sliding movement piston 129. The striker 143 then collides with (strikes) an intermediate element in the form impact bolt 145 that is slidably disposed within the tool holder 137 and transmits the striking f to the hammer bit 119 via the impact bolt 145. The impact bolt 145 includes a large-diam portion 145a, a small-diameter portion 145b and a tapered portion 145c. The large-diam portion 145a is fitted in close contact with the inner surface of the tool holder 137, whi predetermined extent of space is defined between the small-diameter portion 145b and the i peripheral surface of the tool holder 137. The tapered portion 145c is formed in the boun region between the both diameter portions 145a and 145b. The impact bolt 145 is disposed wi the tool holder 137 in such an orientation that the large-diameter portion 145a is on the front and the small-diameter portion 145b is on the rear side.

The hammer drill 101 includes a positioning member 151 that positions the body 103 respect to the workpiece by contact with the impact bolt 145 when the impact bolt 145 is pus rearward (toward the piston 129) together with the hammer bit 119 under loaded condition which the hammer bit 119 is pressed against the workpiece by the user applying a pressing f forward to the body 103 while holding the handgrip 109. The positioning member 151 is a part including a ring-like elastic member in the form of a rubber ring 153, a front-side hard m washer 155 joined to the axially front surface of the rubber ring 153, and a rear-side hard m washer 157 joined to the axially rear surface of the rubber ring 153. The positioning member is loosely fitted onto the small-diameter portion 145b of the impact bolt 145. The rubber ring and the rear metal washer 157 are disposed with a predetermined clearance from small diameter portion 145b.

When the hammer bit 119 is pressed against the workpiece and the impact bolt 14 pushed rearward, the tapered portion 145c of the impact bolt 145 contacts the front metal was 155 and the rear metal washer 157 contacts the tool holder 137 via a retaining ring 158. The holder 137 is mounted to the gear housing 107 such that it is prevented from relative moveme the axial direction and allowed to rotate on its axis. Thus, the rubber ring 153 of the position member 151 elastically connects the impact bolt 145 to the tool holder 137. The front m washer 155 has a tapered bore, and when the impact bolt 145 is pushed rearward, the tape surface of the front metal washer 155 comes in surface contact with the tapered portion 145c of impact bolt 145.

The hammer drill 101 according to the embodiment includes an impact damper 161 cushioning the impact force defined by a reaction force that is caused by rebound of the harm bit 119 after the striking movement of the hammer bit 119 during hammering operation on workpiece. The impact damper 161 includes the cylinder 141 that is made of hard metal contacts the impact bolt 145 via the front metal washer 155 and a compression coil spring 165 normally biases the cylinder 141 forward toward the impact bolt 145. According to embodiment, the cylinder 141 is utilized as a weight of the impact damper 161, while the cylin 141 is an existing part forming the main part of the hammer drill 101. The cylinder 141, compression coil spring 165 and the front metal washer 155 are features that correspond to “weight”, the “elastic element” and the “intervening member”, respectively, according to invention.

The cylinder 141 is mounted to the gear housing 107 such that it is allowed to move respect to the gear housing 107 in the axial direction of the cylinder 141 (in the axial direction the hammer bit 119). The cylinder 141 has a front portion having a smaller diameter or a fr small-diameter cylindrical portion 141b. The front small-diameter cylindrical portion 141b of cylinder 141 extends forward through the clearance between the inner surfaces of the rubber ri 153 and rear-side metal washer 157 of the positioning member 151 and the outer surface of small-diameter portion 145b of the impact bolt 145. The front end surface of the fr small-diameter cylindrical portion 141b comes in surface contact with a radially inward portion the rear surface of the front metal washer 155 of the positioning member 151. The compressi coil spring 165 is disposed on the cylinder 141. One axial end of the compression coil spring 1 is held in contact with a spring receiving ring 167 fixed to the cylinder 141 and the other axial e is in contact with the gear housing 107. Specifically, the compression coil spring 165 is elastica disposed between the cylinder 141 and the gear housing 107 under a predetermined initial load that the cylinder 141 is normally biased forward. The forward position of the cylinder 141 bias forward by the compression coil spring 165 is defined by contact of the front metal washer 155 the positioning member 151 with a stepped position-control stopper 169 formed in the tool hold 137.

As shown in FIGS. 1 and 2, under loaded conditions in which the impact bolt 145 pushed rearward together with the hammer bit 119, the cylinder 141 is in contact with the imp bolt 145 via the front metal washer 155. Therefore when the hammer bit 119 and the impact b 145 are caused to rebound by receiving a reaction force from the workpiece after stiki movement, the reaction force from the impact bolt 145 is transmitted to the cylinder 141 which held in contact with the impact bolt 145 via the front metal washer 155. Thus, the front me washer 155 forms a reaction force transmitting member. When the cylinder 141 is mov rearward by receiving a reaction force from the impact bolt 145, the compression coil spring 165 pushed by the cylinder 141. As a result, the compression coil spring 165 elastically deforms absorbs the reaction force.

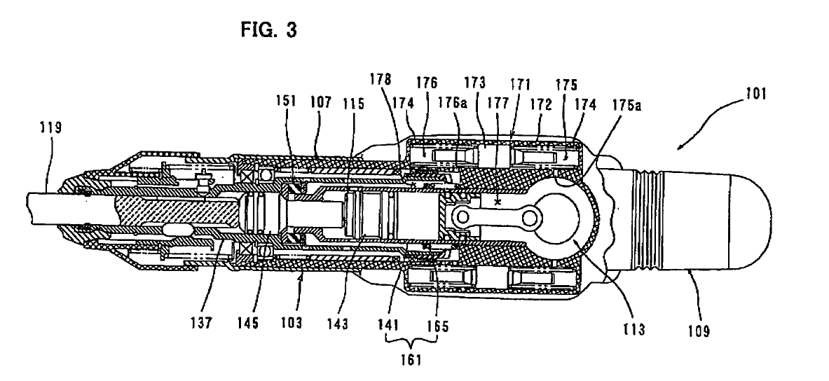

Further, as shown in FIG. 3 showing the hammer drill 101 in sectional plan view, hammer drill 101 includes a pair of dynamic vibration reducers 171. The dynamic vibra reducers 171 are arranged on the both sides of the axis of the hammer bit 119 and have the s construction. Each of the dynamic vibration reducers 171 mainly includes a cylindrical body that is disposed adjacent to the body 103, a vibration reducing weight 173 that is disposed wi the cylindrical body 172, and biasing springs 174 that are disposed on the right and left sides of weight 173. The biasing springs 174 exert a spring force on the weight 173 in a direction tow each other when the weight 173 moves in the axial direction of the cylindrical body 172 (in axial direction of the hammer bit 119). The dynamic vibration reducer 171 having above-described construction serves to reduce impulsive and cyclic vibration caused when hammer bit 119 is driven. Specifically, the weight 173 and the biasing springs 174 serv vibration reducing elements in the dynamic vibration reducer 171 and cooperate to pass reduce vibration of the body 103 of the hammer drill 101 on which a predetermined outside f (vibration) is exerted. Thus, the vibration of the hammer drill 101 of this embodiment can effectively alleviated or reduced.

Further, in the dynamic vibration reducer 171, a first actuation chamber 175 an second actuation chamber 176 are defined on the both sides of the weight 173 within cylindrical body 172. The first actuation chamber 175 communicates with the crank chamber via a first communicating portion 175a. The crank chamber 177 is normally hermetic prevented from communication with the outside. The second actuation chamber communicates with a cylinder accommodating space 178 of the gear housing 107 via a sec communicating portion 176a. The pressure within the crank chamber 177 fluctuates when motion converting mechanism 113 is driven. Such pressure fluctuations are caused when piston 129 forming the motion converting mechanism 113 linearly moves within the cylinder The fluctuating pressure caused within the crank chamber 177 is introduced from the communicating portion 175a to the first actuation chamber 175, and the weight 173 of dynamic vibration reducer 171 is actively driven. In this manner, the dynamic vibration redu 171 performs a vibration reducing function. Specifically, in addition to the above-descri passive vibration reducing function, the dynamic vibration reducer 171 functions as an act vibration reducing mechanism for reducing vibration by forced vibration in which the weight is actively driven. Thus, the vibration which is caused in the body 103 during hammer operation can be further effectively reduced or alleviated.

Operation of the hammer drill 101 constructed as described above will now be explai When the driving motor 111 (shown in FIG. 1) is driven, the rotating output of the driving mo 111 causes the driving gear 121 to rotate in the horizontal plane. When the driving gear 121 rot the crank plate 125 revolves in the horizontal plane via the driven gear 123 that engages with driving gear 121. Then, the piston 129 slidingly reciprocates within the cylinder 141 via the cra arm 127. The striker 143 reciprocates within the cylinder 141 and collides with (strikes) impact bolt 145 by the action of the air spring function within the cylinder 141 as a result of sliding movement of the piston 129. The kinetic energy of the striker 143 which is caused by collision with the impact bolt 145 is transmitted to the hammer bit 119. Thus, the hammer bit performs a striking movement in its axial direction, and the hammering operation is performed a workpiece.

The rotating output of the driving motor 111 is transmitted from the transmission g 131 that engages with the driving gear 121 to the small bevel gear 134 via the transmission s 133. Thus, the small bevel gear 134 rotates in a horizontal plane. The large bevel gear 135 engages with the small bevel gear 134 is then caused to rotate in a vertical plane, which in causes the tool holder 137 and the hammer bit 119 held by the tool holder 137 to rotate toget with the large bevel gear 135. Thus, the hammer bit 119 performs a striking movement in the a direction and a rotary movement in the circumferential direction, so that the hammer d operation is performed on the workpiece.

The above-described operation is performed in the state in which the hammer bit 119 pressed against the workpiece and in which the hammer bit 119 and the tool holder 137 are push rearward. The impact bolt 145 is pushed rearward when the tool holder 137 is pushed rearwa The impact bolt 145 then contacts the front metal washer 155 of the positioning member 151 the rear metal washer 157 contacts the tool holder 137 via the retaining ring 158. The tool hol 137 is mounted to the gear housing 107 such that it is locked against relative movement in axial direction. Therefore, the gear housing 107 receives the force of pushing in the hammer 119, via the tool holder 137, so that the body 103 is positioned with respect to the workpiece. this state, a hammering operation or a hammer drill operation is performed. This state is shown FIGS. 1 and 2. At this time, as described above, the front end surface of the cylinder 141 wh forms the weight of the impact damper 161 is held in contact with the rear surface of the f metal washer 155 of the positioning member 151.

After striking movement of the hammer bit 119 upon the workpiece, the hammer bit 1 is caused to rebound by the reaction force from the workpiece. This rebound causes the imp bolt 145 to be acted upon by a rearward reaction force. At this time, the cylinder 141 is in cont with the impact bolt 145 via the front metal washer 155 of the positioning member 151. Theref in this state of contact via the front metal washer 155, the reaction force of the impact bolt 145 transmitted to the cylinder 141. In other words, momentum is exchanged between the impact 145 and the cylinder 141. By such transmission of the reaction force, the impact bolt 145 is h substantially at rest in the striking position, while the cylinder 141 is caused to move rearward the direction of action of the reaction force. As shown in FIG. 3, the rearward moving cylin 141 elastically deforms the compression coil spring 165, and the reaction force of the weight is absorbed by such elastic deformation.

At this time, the reaction force of the impact bolt 145 also acts upon the rubber ring which is kept in contact with the impact bolt 145 via the front metal washer 155. Generally, transmission rate of a force of one object is raised in relation to the Young's modulus of the o object placed in contact with the one object. According to this embodiment, the cylinder 141 made of hard metal and has high Young's modulus, while the rubber ring 153 made of rubber low Young's modulus. Therefore, most of the reaction force of the impact bolt 145 is transmit to the cylinder 141 which has high Young's modulus and which is placed in contact with the me impact bolt 145 via the hard front metal washer 155. Thus, the impact force caused by rebound the hammer bit 119 and the impact bolt 145 can be efficiently absorbed by the rearward movem of the cylinder 141 and by the elastic deformation of the coil spring 165 which is caused by movement of the cylinder 141. As a result, vibration of the hammer drill 101 can be reduced.

Thus, most of the reaction force that the hammer bit 119 and the impact bolt 145 recei from the workpiece after the striking movement can be transmitted from the impact bolt 145 to cylinder 141. The impact bolt 145 is placed substantially at rest as viewed from the striki position. Therefore, only a small reaction force acts upon the rubber ring 153, Accordingly, or a slight amount of elastic deformation is caused in the rubber ring 153 by such reaction force, a subsequent repulsion is also reduced. Further, the reaction force of the impact bolt 145 can absorbed by the impact damper 161 which includes the cylinder 141 and the compression spring 165. Therefore, the rubber ring 153 can be made hard. As a result, such rubber ring can provide correct positioning of the body 103 with respect to the workpiece.

In this embodiment, the cylinder 141 which is an existing part forming the main par the hammer drill 101 is utilized as a weight of the impact damper 161. Therefore, the cushion weight can be easily secured without increasing the mass of the hammer drill 101. Thus, hammer drill 101 with the impact damper 161 can be substantially reduced in weight and can rationalized in its construction.

Further, according to this embodiment, the reaction force from the workpiece transmitted to the cylinder 141 via the hammer bit 119 and the impact bolt 145. Thus, the react force from the workpiece can be transmitted to the cylinder 141 in a concentrated manner with being scattered midway on the transmission path. As a result, the efficiency of transmission of reaction force to the cylinder 141 increases, so that the impact absorbing function can be enhan Further, in this embodiment, the impact bolt 145 contacts the cylinder 141 and the rubber ring via a common hard metal sheet or the front metal washer 155. Therefore, the reaction force of impact bolt 145 can be transmitted from one point to two members via a common member, that from the impact bolt 145 to the cylinder 141 and the rubber ring 153 via the front metal was 155. Further, the structure can be simplified.

### Second Embodiment

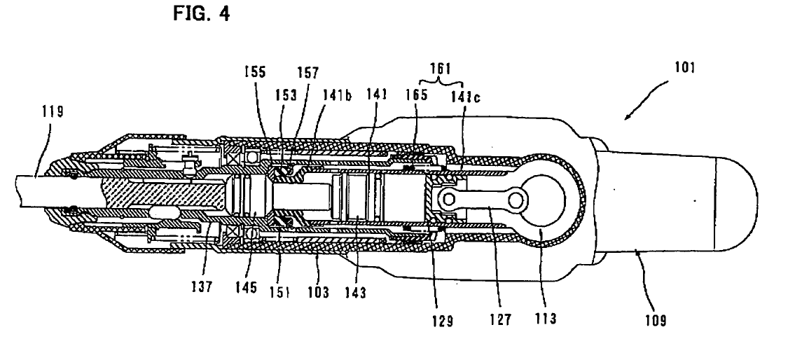

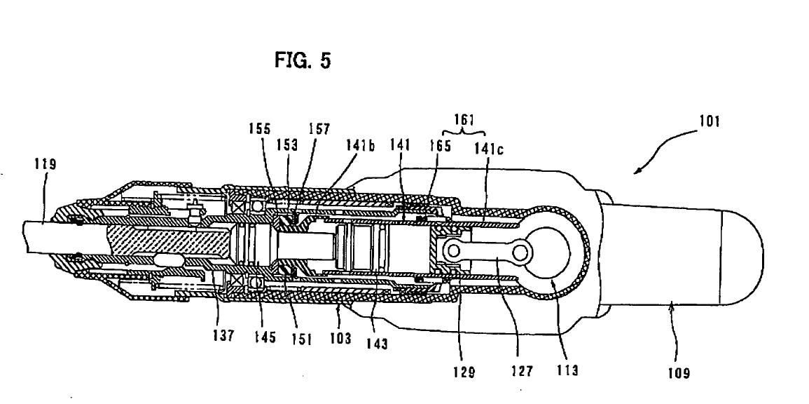

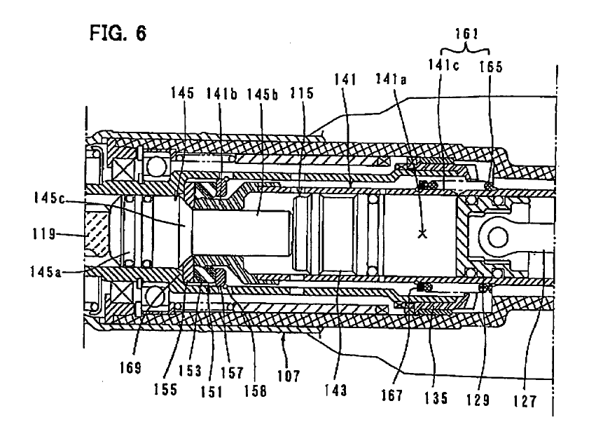

Now, a second embodiment of the present invention will be described with reference FIGS. 4 to 6. FIG. 4 shows the hammer drill under loaded conditions in which the hammer bit is pressed against the workpiece. FIG. 5 shows the hammer drill during operation of the imp damper. FIG. 6 is a partially enlarged view of FIG. 4. In this embodiment, the cylinder forming the weight of the impact damper 161 is separated into two parts, i.e. a cylinder body 1 for housing the piston 129 and the striker 143 and the front small-diameter cylindrical port 141b which contacts the front metal washer 155 of the positioning member 151. In the o points, it has the same construction as the first embodiment. Components or elements in second embodiment which are substantially identical to those in the first embodiment are gi like numerals as in the first embodiment and will not be described or only briefly described.

The front end portion of the cylinder body 141c is loosely fitted into the rear end port of the front small-diameter cylindrical portion 141b. The cylinder body 141c can move in axial direction with respect to the front small-diameter cylindrical portion 141b and the axial f end surface of the cylinder body 141c can come in surface contact with the rear end surface of front small-diameter cylindrical portion 141b. The cylinder body 141c is biased forward by compression coil spring 165 and contacts the radially inward portion of the rear surface of front metal washer 155 of the positioning member 151 via the front small-diameter cylindr portion 141b. Under loaded conditions in which the impact bolt 145 is pushed rearward toge with the hammer bit 119, the front metal washer 155 is held in surface contact with the tape surface of the impact bolt 145. Thus, when the hammer bit 119 is caused to rebound by receiv the reaction force from the workpiece after the striking movement of the hammer bit 119, reaction force of the impact bolt 145 is transmitted to the cylinder body 141c that is in contact the impact bolt 145. The cylinder body 141 is a feature that corresponds to the “weight” and “rear cylinder element”, and the front metal washer 155 and the front small-diameter cylindr portion 141b are features that correspond to the “intervening member” and the “front cyli element”, respectively, according to this invention.

Under loaded conditions in which the hammer bit 119 is pressed against the workpi when the hammer bit 119 and the impact bolt 145 are pushed rearward as shown in FIGS. 4 an the tapered portion 145c of the impact bolt 145 contacts the front metal washer 155 of positioning member 151, and the rear metal washer 157 contacts the tool holder 137 via retaining ring 158. Thus, the force of pushing in the hammer bit 119 is received by the housing 107 of the body 103 via the tool holder 137.

In this state, the hammer bit 119 and the impact bolt 145 are caused to rebound by reaction force from the workpiece after the striking movement of the hammer bit 119. reaction force of the impact bolt 145 is transmitted to the cylinder body 141c which is place contact with the impact bolt 145 via the front metal washer 155 and the front small-diam cylindrical portion 141b. Thus, as shown in FIG. 5, the cylinder body 141c is caused to m rearward in the direction of action of the reaction force and elastically deforms the compres coil spring 165. As a result, the impact force caused by rebound of the hammer bit 11 efficiently absorbed by the rearward movement of the cylinder body 141c and the resulting ela deformation of the compression coil spring 165. Thus, vibration of the hammer drill 101 can reduced.

According to this embodiment, with a two-part structure of the cylinder 141, cylinder 141 can be more easily manufactured and an ease of mounting the striker 143 to cylinder body 141c can be enhanced. Further, according to this embodiment, the f small-diameter cylindrical portion 141b and the cylinder body 141c can be easily assemb together by fitting together.

### Third Embodiment

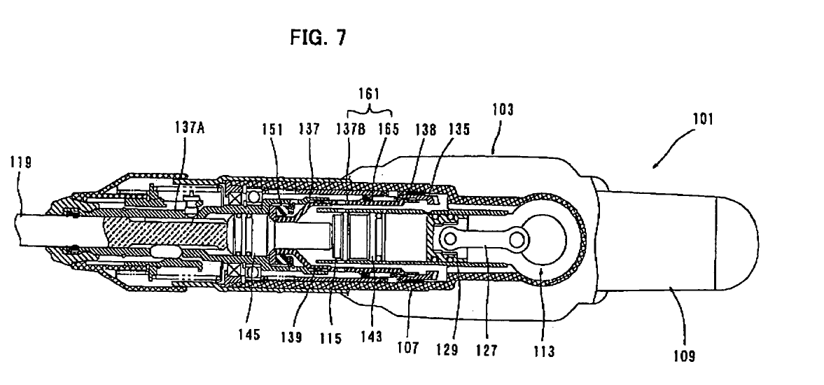

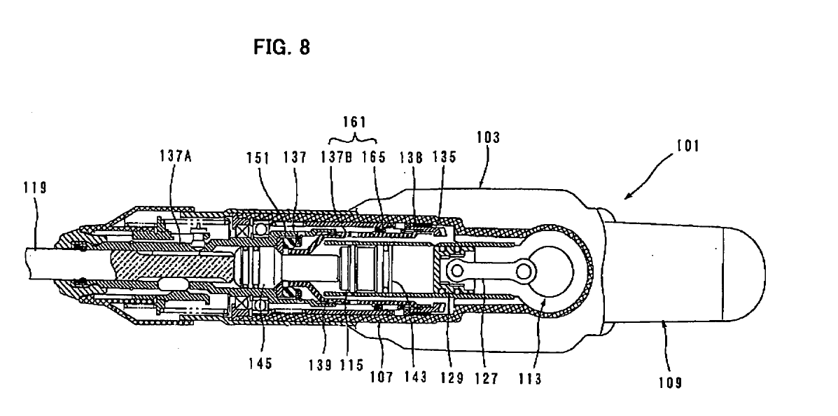

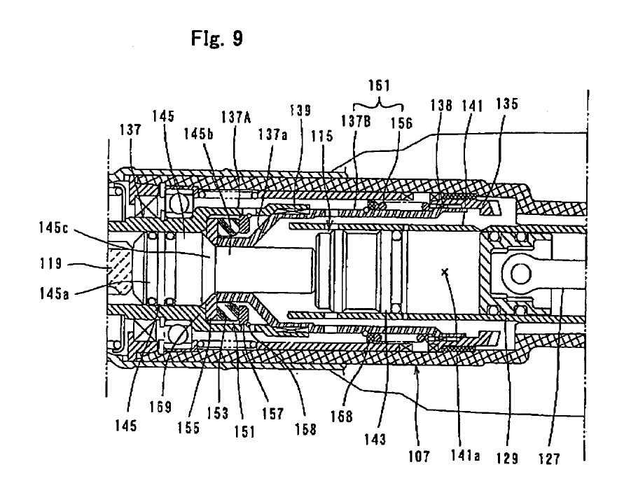

Third embodiment of the present invention will be described with reference to FIG. to 9. FIG. 7 shows the hammer drill under loaded conditions in which the hammer bit 11 pressed against the workpiece. FIG. 8 shows the hammer drill during operation of the im damper. FIG. 9 is a partially enlarged view of FIG. 7. In this embodiment, the impact damper is comprised of existing parts of the hammer drill 101, i.e. the hard metal tool holder 137 an compression coil spring 165 that biases the tool holder 137 toward the impact bolt 145 (forw In the other points, it has the same construction as the first embodiment. Components or ele in the third embodiment which are substantially identical to those in the first embodiment given like numerals as in the first embodiment and will not be described or only briefly descri Further, in this embodiment, the cylinder 141 does not have the front small-diameter cylind portion 141b (see FIG. 2) and is fixedly mounted to the gear housing 107.

In this embodiment, the tool holder 137 has a two-part structure separated into a fro holding part 137A for holding the hammer bit 119 and a rear extension 137B forming a transmitting part. The front bit holding part 137A and the rear extension 137B are features correspond to the “front tool holder element” and the “rear tool holder element”, respect according to the invention. The front bit holding part 137A is rotatably mounted to the housing 107 such that it is locked against relative movement in the axial direction. The exten 137B is disposed on the outside of the cylinder 141. The axial rear end portion of the exten 137B is connected to the large bevel gear 135 via a spline joint 138, and the axial middle porti the extension 137B is connected to the hit holding part 137A via a spline joint 139. Thus, extension 137B is disposed such that it is allowed to move a predetermined distance in the a direction and can transmit rotation of the large bevel gear 135 to the bit holding part 137A.

Further, the extension 137B has a small-diameter cylindrical portion 137a extend forward from the front spline joint 139. The small-diameter cylindrical portion 137a exte forward through the clearance between the inner surfaces of the rubber ring 153 and rear-s metal washer 157 of the positioning member 151 and the outer surface of the small-diam portion 145b of the impact bolt 145. The front end surface of the front small-diameter cylind portion 141b comes in surface contact with the radially inward portion of the rear surface of front metal washer 155. The compression coil spring 165 is disposed on the extension 137B. axial end of the compression coil spring 165 is held in contact with a spring receiving ring fixed to the extension 13713 and the other axial end is in contact with the axial front end surface the large bevel gear 135. Specifically, the compression coil spring 165 is elastically dispo between the extension 137B and the large bevel gear 135 under a predetermined initial load, that the extension 137B is normally biased forward. The forward position of the extension 13 biased forward by the compression coil spring 165 is defined by contact of the front metal was 155 with the stepped position-control stopper 169 formed in the tool holder 137. The extens 137B, the compression coil spring 165 and the front metal washer 155 are features that coresp to the “weight”, the “elastic element” and the “intervening member”, respectively.

As shown in FIGS. 7 and 9, under loaded conditions in which the impact bolt 145 pushed rearward together with the hammer bit 119, the extension 137B is in contact with impact bolt 145 via the front metal washer 155. Therefore, when the hammer bit 119 and impact bolt 145 are caused to rebound by receiving a reaction force from the workpiece a striking movement, the reaction force from the impact bolt 145 is transmitted to the extens 137B which is held in contact with the impact bolt 145 via the front metal washer 155. Thus, front metal washer 155 forms a reaction force transmitting member. When the extension 1371 moved rearward by receiving a reaction force from the impact bolt 145, the compression spring 165 is pushed by the extension 137B. As a result, the compression coil spring elastically deforms and absorbs the reaction force.

According to this embodiment, under loaded conditions in which the hammer bit 119 pressed against the workpiece, when the hammer bit 119 and the impact bolt 145 are pus rearward, as shown in FIGS. 7 and 9, the tapered portion 145c of the impact bolt 145 contacts front metal washer 155 of the positioning member 151, and the rear metal washer 157 contacts bit holding part 137A of the tool holder 137 via the retaining ring 158. Thus, the force of push in the hammer bit 119 is received by the gear housing 107 of the body 103 via the bit holding 137A.

In this state, when a hammer drill operation is performed by the hammer bit 119, hammer bit 119 and the impact bolt 145 are caused to rebound by the reaction force from workpiece after the striking movement of the hammer bit 119. The reaction force of the imp bolt 145 is transmitted to the extension 137B of the tool holder 137 which is placed in contact the impact bolt 145 via the front metal washer 155. Thus, as shown in FIG. 8, the extension 13 is caused to move rearward in the direction of action of the reaction force and elastically defor the compression coil spring 165. As a result, the impact force caused by rebound of the ham bit 119 is efficiently absorbed by the rearward movement of the extension 137B and the result elastic deformation of the compression coil spring 165. Thus, vibration of the hammer drill 1 can be reduced.

With respect to the above-described first to third embodiments, the present invention also be applied to a hammer which performs a hammering operation on a workpiece by appl only a striking force to the hammer bit 119 in the axial direction. Further, as the weight of impact damper 161, the cylinder 141 is utilized in the first and second embodiments, while the holder 137 is utilized in the third embodiment. However, it may be configured such that both cylinder 141 and the tool holder 137 are utilized as the weight of the impact damper 161.

Further, a counter weight may be used in place of the dynamic vibration reducer Further, in the above-described first to third embodiments, a crank mechanism is adop However, in the case of the construction using the tool holder 137 as the weight of the im damper 161, for example a motion converting mechanism which converts rotation of the rota element into swinging motion of a swinging member and then converts the swinging motion linear motion of the piston may be used in place of the crank mechanism.

### REFERENCE EXAMPLE

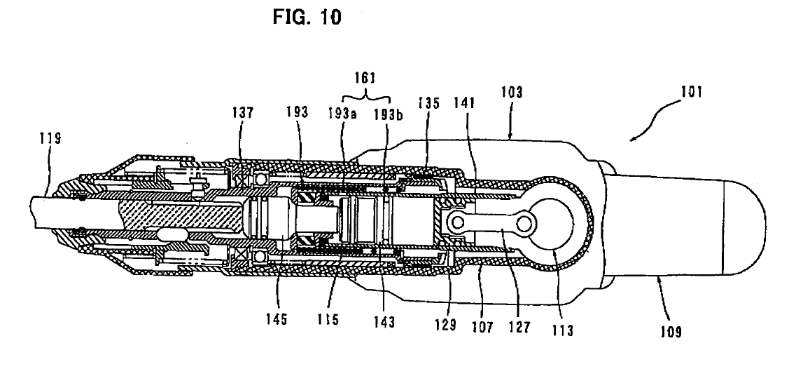

A reference example of an impact power tool is now described with reference to FIG. 10 to 12. A compression coil spring 193 includes a weight part 193a and a spring part 193b w form the impact damper 161. The weight part 193a and the spring part 193b are constructed one component element by increasing the number of turns of an end turn part of the compress coil spring 193. The end turn part represents an apparently flat portion (generally perpendicula the axial direction) on either end of the compression coil spring 193 which does not function spring. Specifically, in this embodiment, a contact turn region which does not function as a sp is formed by increasing the number of turns of one of the end turn parts of the compression spring 193. The contact turn region has a predetermined length in the axial direction and forms weight part 193a of the impact damper 161. The compression coil spring 193 is disposed in annular space formed between the outer surface of the cylinder 141 and the inner surface of tool holder 137.

The positioning member 151 is configured such that when the impact bolt 145 is push rearward together with the hammer bit 119, the tapered portion 145c of the impact bolt 1 contacts the front metal washer 155 of the positioning member 151 while the rear metal wash 157 contacts the axial front end of the cylinder 141. Thus the rubber ring 153 of the positioni member 151 elastically connects the impact bolt 145 to the cylinder 141 fixedly mounted to gear housing 107. The front metal washer 155 has a tapered bore, and when the impact bolt 14 pushed rearward, the tapered surface of the front metal washer 155 comes in surface contact the tapered portion 145c of the impact bolt 145. Further, the rear metal washer 157 has a genera hat-like sectional shape, having a cylindrical portion of a predetermined length which is fitted on the small-diameter portion 145b of the impact bolt 145 and a flange that extends radially outward from the cylindrical portion. The rear surface of the flange is in surface contact with the axial fr end of the cylinder 141 via a spacer 159.

The compression coil spring 193 is disposed in the annular space formed between 1 cylinder 141 and the tool holder 137 in such an orientation that the weight part 193a is on the fr side and the spring part 193b is on the rear side. The rear end of the spring part 193b is in cont with a spring receiving ring 195 mounted on the tool holder 137. The spring part 193b is put unc a predetermined initial load, so that the weight part 193a is biased forward. Further, the front e of the weight part 193a is normally held in contact with a stepped position-control stopper 1 formed in the tool holder 137, so that the weight part 193a is prevented from moving forwa beyond the striking position. The striking position is a position in which the striker 143 collid with (strikes) the impact bolt 145, and this position coincides with a position in which the reac force is transmitted from the impact bolt 145 to the weight part 193a.

Under loaded conditions in which the impact bolt 145 is pushed rearward together the hammer bit 119, the axial front end of the weight part 193a of the compression coil spring is held in surface contact with the radially outward portion of the rear surface of the front m washer 155 of the positioning member 151. Specifically, the weight part 193a is placed in co with the impact bolt 145 via the front metal washer 155. Thus, when the hammer bit 119 and impact bolt 145 are caused to rebound by receiving the reaction force from the workpiece after striking movement of the hammer bit 119, the reaction force of the impact bolt 145 is transm to the weight part 193a that is held in contact with the impact bolt 145 via the front metal wa 155. The front metal washer 155 forms a reaction force transmitting member and has a la outside diameter than the rubber ring 153. Thus, the axial front end of the weight part 193a contact with an outer region of the front metal washer 155 outward of the outer surface of rubber ring 153. In this embodiment, the hammer drill 101 has the same construction as the embodiment except for the above-described construction of the impact damper 161 and positioning member 151. Components or elements which are substantially identical to those in first embodiment are given like numerals as in the first embodiment and will not be described

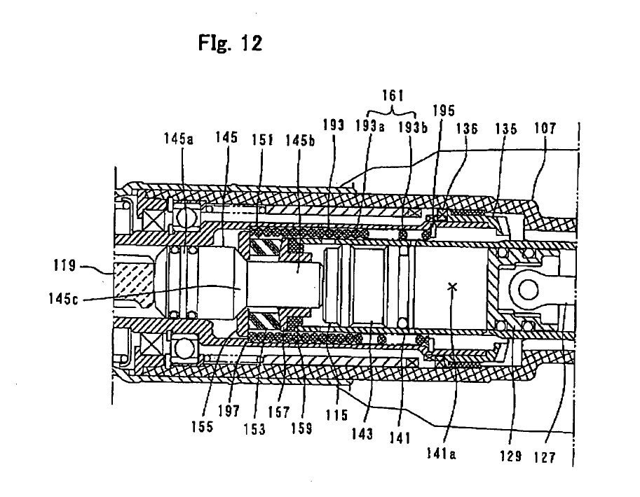

Under loaded conditions in which the hammer bit 119 is pressed against the workp in order to perform a hammer drill operation, when the impact bolt 145 is pushed rearward shown in FIGS. 10 and 12, the tapered portion 145c of the impact bolt 145 contacts the front m washer 155 of the positioning member 151 and the rear metal washer 157 contacts the axial f end of the cylinder 141 via the spacer 159. Therefore, the fore of pushing in the hammer bit is received by the cylinder 141 fixedly mounted to the gear housing 107. Thus, the body 10 positioned with respect to the workpiece. In this state, the hammer drill operation is perform At this time the front end surface of the weight part 193a of the compression coil spring contacts the rear surface of the front metal washer 155 of the positioning member 151.

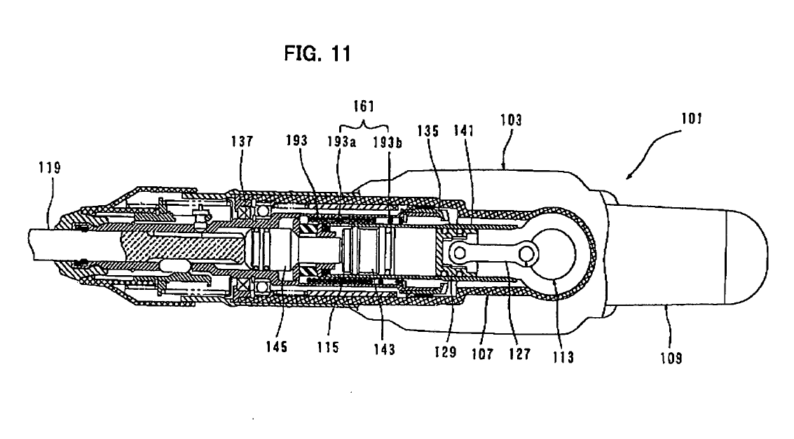

In this state when a hammer drill operation is performed by the hammer bit 119, hammer bit 119 and the impact bolt 145 are caused to rebound by the reaction force from workpiece after the striking movement of the hammer bit 119. The reaction force of the imp bolt 145 is transmitted to the weight part 193a of the compression coil spring 193 which is hel contact with the impact bolt 145 via the front metal washer 155. Thus, as shown in FIG. 11, weight part 193a is caused to move rearward in the direction of action of the reaction force elastically deforms the spring part 193b. As a result, the impact force caused by rebound of hammer bit 119 is absorbed by the movement of the weight part 193a and the elastic deformat of the spring part 193b. Thus, vibration of the hammer drill 101 can be reduced.

Because the weight part 193a of the impact damper 161 is formed by increasing number of turns of the end turn part of the compression coil spring 193, even in the construction which the impact damper 161 is additionally provided, the number of component parts can minimized and the structure can be simplified. Further, the mass of the weight part 193a can readily adjusted by changing the number of turns of the end turn part of the compression spring 193. Further, the compression coil spring 193 of this embodiment may comprise a squ spring having a square section.

### DESCRIPTION OF NUMERALS

101 hammer drill
103 body (tool body)
105 motor housing
107 gear housing
109 handgrip
109a pivot
109b elastic spring
111 driving motor
113 motion converting mechanism
115 striking mechanism
117 power transmitting mechanism
119 hammer bit
121 driving gear
123 driven gear
125 crank plate
126 eccentric shaft
127 crank arm
128 connecting shaft
129 piston
131 transmission gear
133 transmission shaft
134 small bevel gear
135 large bevel gear
136 engagement clutch
137 tool holder
137A bit holding part
137B extension
137a small-diameter cylindrical portion
141 cylinder
141a air-chamber
141b front small-diameter cylindrical portion
141c cylinder body
143 striker
145 impact bolt (hammer actuating member)
145a large-diameter portion
145b small-diameter portion
145c tapered portion
151 positioning member
153 rubber ring
155 front metal washer
157 rear metal washer
158 retaining ring
159 spacer
161 impact damper
165 compression coil spring
167 spring receiving ring
169 stopper
171 dynamic vibration reducer
172 cylindrical body
173 weight
174 biasing spring
175 first actuation chamber
175a first communicating portion
176 second actuation chamber
176a second communicating portion
177 crank chamber
178 cylinder accommodating space
193 compression coil spring
193a weight part
193b spring part
195 spring receiving ring
197 stopper

What we claim is:

1. An impact power tool comprising:
a tool body,
a hammer actuating member that is disposed in a tip end region of the tool body a performs a predetermined hammering operation on a workpiece by reciprocating movement in axial direction,
a tool holder to entirely or partially hold the hammer actuating member,
a driving mechanism that is disposed on the rear side of the tool body opposite hammer actuating member and linearly drives the hammer actuating member,
a cylinder that houses the driving mechanism,
a weight placed in contact with the hammer actuating member to move rearward in tool body by a reaction force transmitted from the hammer actuating member when the ham actuating member performs a hammering operation on the workpiece and
an elastic element elastically deformed when the weight moves rearward in the t body to push the elastic element such that the elastic element absorbs the reaction fo transmitted to the weight, wherein the weight is defined one or both of the cylinder and the t holder.

2. The impact power tool as defined in claim 1, wherein the weight is placed in cont with the hammer actuating member via an intervening member made of metal and is caused move rearward in the tool body by receiving a reaction force from the hammer actuating mem via the intervening member.

3. The impact power tool as defined in claim 1, wherein, while the weight entirely partially comprises the cylinder, the cylinder includes a rear cylinder element that comprises a portion of the cylinder and defines the weight and a front cylinder element that comprises a portion of the cylinder, and wherein the rear cylinder element is separated from the front cyli element and placed in contact with the hammer actuating member via the front cylinder eleme via the metal intervening member and the front cylinder element in series, and the rear cyl element is caused to move rearward in the tool body by a reaction force transmitted from hammer actuating member via the front cylinder element or via the metal intervening member the front cylinder element.

4. The impact power tool as defined in claim 1, wherein, when the weight entirely partially comprises the tool holder, the tool holder includes a rear tool holder element comprises a rear portion of the tool holder and defines the weight and a front tool holder ele that comprises a front portion of the tool holder, and wherein the rear tool holder eleme separated from the front tool holder element and placed in contact with the hammer actua member, and the rear tool holder element is caused to move rearward in the tool body by a reac force transmitted from the hammer actuating member.

5. The impact power tool as defined in claim 1, wherein the hammer actuating mem comprises an impact bolt that is linearly driven in the axial direction by the driving mechani and a tool bit that is caused to reciprocate by receiving a striking force from the impact bolt thereby performs a hammering operation on the workpiece, and wherein, during hammer operation on the workpiece, the impact bolt transmits the reaction force from the workpiece to weight by contact with the weight.

6. The impact power tool as defined in claim 1, wherein the hammer actuating mem further comprises an impact bolt linearly driven in the axial direction by the driving mechan and a tool bit linearly moved by receiving a striking force from the impact bolt to perfo hammering operation on the workpiece, and wherein the tool holder rotates on the axis of hammer actuating member to make the tool bit rotate such that the tool hit performs a ham drill operation by linear striking movement via the driving mechanism and the impact bolt and rotation via the tool holder.

7. The impact power tool as defined in claim 1, wherein the elastic element is provi under a predetermined initial load to normally bias the cylinder forward.

8. The impact power tool as defined in claim 1 further comprising a dynamic vibra reducer having a vibration reducing weight and at least one biasing spring that biases the vibra reducing weight, wherein the vibration reducing weight is positively driven by utilizing a pres fluctuation caused in relation to the movement of the driving mechanism within the cylinder.
